(19) United States
(12) Patent Application Publication
(10) Pub. No.: US 2023/0073328 A1
(43) Pub. Date: Mar. 9, 2023

(54) RADIO BASE STATION, RADIO COMMUNICATION SYSTEM, CONTROL CIRCUIT, STORAGE MEDIUM, AND RADIO COMMUNICATION METHOD

(71) Applicant: Mitsubishi Electric Corporation, Chiyoda-ku, Tokyo (JP)

(72) Inventors: Yuji MIYAKE, Tokyo (JP); Tetsuya AOYAMA, Tokyo (JP)

(73) Assignee: Mitsubishi Electric Corporation, Chiyoda-ku, Tokyo (JP)

(21) Appl. No.: 17/798,201

(22) PCT Filed: Feb. 14, 2020
(86) PCT No.: PCT/JP2020/005892

§ 371 Date: Aug. 8, 2022

(51) Int. Cl. H04W 56/00

(52) U.S. Cl. CPC H04W 56/0015

(57) ABSTRACT

A radio base station includes: a timing difference measuring unit that measures a timing difference between a reference timing of the radio base station and a reference timing of another radio base station adjacent to the radio base station, using a reference signal received from the adjacent radio base station; a timing correction controlling unit that calculates a first timing correction amount by which to correct the reference timing of the radio base station, and a second timing correction amount by which to correct the reference timing of the adjacent radio base station, for synchronization of the reference timing of the radio base station with the reference timing of the adjacent radio base station, based on the timing difference; and a base station controlling unit that notifies the adjacent radio base station of the second timing correction amount.

### FIELD

The present disclosure relates to a radio base station, a radio communication system, a control circuit, a storage medium, and a radio communication method for building a radio communication system with a plurality of radio base stations.

### BACKGROUND

Known radio base stations building a radio communication system need to temporally synchronize reference timings with neighboring radio base stations in order to, for example, avoid interference between radio base stations, and achieve handover for a wireless terminal to seamlessly switch a radio base station to communicate with. A reference timing is timing serving as a standard for starting transmission of radio signals between radio base stations. The radio base stations can also synchronize points of time managed by the individual radio base stations as synchronization of reference timings. The radio base stations need to synchronize the reference timings and transmit radio signals without collisions of such radio signals with one another in radio communication services that allow a plurality of radio base stations and wireless terminals to share time and frequency such as frequency hopping, code division multiple access (CDMA) in addition to radio communication services using the time division multiple access (TDMA) method.

In the presence of a large timing difference between reference timings of the radio base stations, the individual radio base stations need to perform timing correction until the timing difference is reduced to an allowable value. Patent Literature 1 teaches a technology for reducing a timing difference between a plurality of radio base stations by notifying the radio base stations of correction information in a case where a wireless terminal connected with the radio base stations has received time slots from the radio base stations and detected a difference between reception timings that is deviated from a reference value by the allowable value or larger. Although the wireless terminal initiates the timing correction among the radio base stations in Patent Literature 1, the radio base stations may perform timing correction when radio signals can be received between the radio base stations.

### CITATION LIST

### Patent Literature

Patent Literature 1: Japanese Patent Application Laid-open No. 2008-160618

### SUMMARY

### Technical Problem

In the presence of radio base stations that transmit radio signals at plural, in particular, more than two different reference timings, the conventional technology described above unfortunately experiences a problem of taking a possible long time until all the radio base stations complete timing corrections and establish synchronization with one another, depending on a reference value determined to cause synchronization between radio base stations to converge.

The present disclosure has been made in view of the above, and an object thereof is to provide radio base stations capable of shortening time taken to establish synchronization between radio base stations.

### Solution to Problem

To solve the above problem and achieve the object, the present disclosure provides a radio base station being a first radio base station among a plurality of radio base stations of a radio communication system. The radio base station comprises: a timing difference measuring unit to measure a timing difference between a reference timing of the first radio base station and a reference timing of a second radio base station adjacent to the first radio base station, using a reference signal received from the second radio base station for synchronization of a reference timing that is timing serving as a standard for starting transmission of a radio signal between radio base stations; a timing correction controlling unit to calculate a first timing correction amount and a second timing correction amount for synchronization of the reference timing of the first radio base station with the reference timing of the second radio base station, on the basis of the timing difference, the first timing correction amount being a timing correction amount by which to correct the reference timing of the first radio base station, the second timing correction amount being a timing correction amount by which to correct the reference timing of the second radio base station; and a base station controlling unit to perform control to notify the second radio base station of the second timing correction amount.

### Advantageous Effects of Invention

The radio base station according to the present disclosure produces an effect of shortening the time taken to establish the synchronization between the radio base stations.

### BRIEF DESCRIPTION OF DRAWINGS

FIG. 1 is a diagram illustrating an example of a configuration of a radio communication system according to an embodiment.

FIG. 2 is a block diagram illustrating an example of a configuration of a radio base station according to the present embodiment.

FIG. 3 is a diagram illustrating an example for explaining the operation of radio base stations in the radio communication system according to the present embodiment.

FIG. 4 is a diagram illustrating a situation under which radio base stations installed in an area 51-2 have resumed operation after the situation illustrated in FIG. 3 in the radio communication system according to the present embodiment.

FIG. 5 is a diagram illustrating an example of relation of reference timings of radio base stations in different areas in the radio communication system according to the present embodiment.

FIG. 6 is a first diagram illustrating an example of timing correction of reference timings performed by radio base stations in the radio communication system according to the present embodiment.

FIG. 7 is a flowchart illustrating operation for establishing inter-radio-base-station synchronization when a radio base station according to the present embodiment has received reference signals having different reference timings from a plurality of radio base stations.

FIG. 8 is a second diagram illustrating an example of timing correction of reference timings performed by radio base stations in the radio communication system according to the present embodiment.

FIG. 9 is a third diagram illustrating an example of timing correction of reference timings performed by radio base stations in the radio communication system according to the present embodiment.

FIG. 10 is a flowchart illustrating the operation of radio base stations in receipt of timing correction amounts according to the present embodiment.

FIG. 11 is a diagram illustrating an example of a configuration of processing circuitry in a case where the processing circuitry included in a radio base station according to the present embodiment is implemented by a processor and a memory.

FIG. 12 is a diagram illustrating an example of processing circuitry in a case where the processing circuitry included in a radio base station according to the present embodiment is constituted by dedicated hardware.

### DESCRIPTION OF EMBODIMENTS

A radio base station, a radio communication system, a control circuit, a storage medium, and a radio communication method according to an embodiment of the present disclosure will be described in detail below with reference to the drawings. Note that the present disclosure is not limited to the embodiment.

### Embodiment

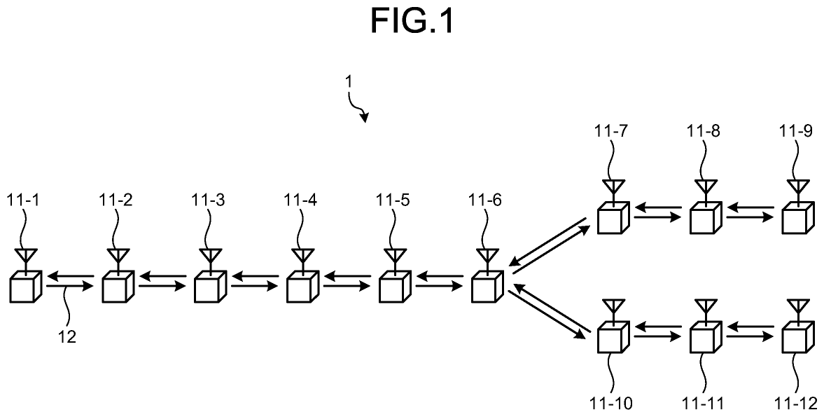

FIG. 1 is a diagram illustrating an example of a configuration of a radio communication system 1 according to an embodiment. The radio communication system 1 includes a plurality of radio base stations 11-1 to 11-12. In the description below, the radio base stations 11-1 to 11-12 will be simply referred to as radio base stations 11 when the radio base stations 11-1 to 11-12 are not distinguished from each other. Each radio base station 11 communicates with and provides communication services to radio terminals, which are not illustrated, present in a coverage area.

Each radio base station 11 transmits and receives a reference signal 12 to and from adjacent radio base stations 11. The reference signal 12, which relates to inter-radio-base-station synchronization, is a radio signal for synchronizing a reference timing. The reference timing is timing that serves as a standard for starting transmission of a radio signal between radio base stations. Each radio base station 11 of the radio communication system 1 transmits and receives the reference signal 12 to determine the reference timing relating to the timing for transmitting radio signals between the radio base stations, and perform timing correction for inter-radio-base-station synchronization. As a result of this timing correction, the inter-radio-base-station synchronization is established. The reference signal 12 may be a special radio signal for inter-radio-base-station synchronization, or may be a radio signal, a beacon, or the like used in communication between the radio base stations or between the radio base stations 11 and wireless terminals. In the description below, the present radio base station in question is referred to as a first radio base station, where necessary. In addition, the adjacent radio base station 11, which is next to the first radio base station, is referred to as a second radio base station, where necessary.

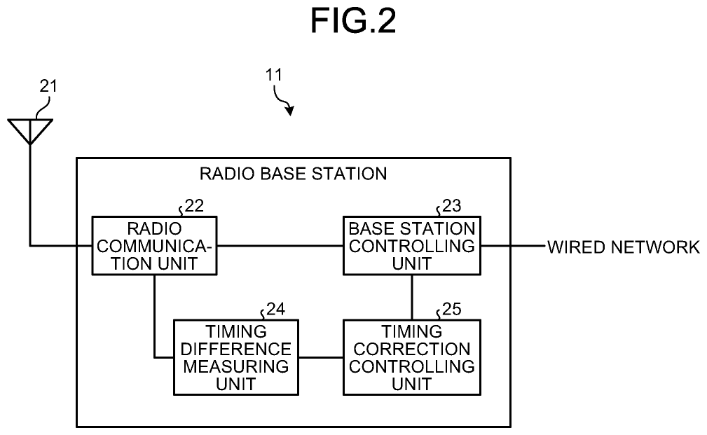

FIG. 2 is a block diagram illustrating an example of a configuration of a radio base station 11 according to the present embodiment. The radio base station 11 includes an antenna 21, a radio communication unit 22, a base station controlling unit 23, a timing difference measuring unit 24, and a timing correction controlling unit 25.

The antenna 21 radiately transmits a radio signal into the air, and receives an incoming radio signal propagated through the air.

The radio communication unit 22 performs a demodulation process, a decoding process, etc. on a radio signal received by the antenna 21. The radio communication unit 22 also performs an encoding process, a modulation process, etc. on transmission data obtained from the base station controlling unit 23.

The base station controlling unit 23 is connected with a radio base station control station via a wired network. The radio base station control station, which is not illustrated, is external to the radio base stations 11 and controls the radio base stations 11. The base station controlling unit 23 outputs information obtained from the radio base station control station via the wired network to the radio communication unit 22. The base station controlling unit 23 obtains information subjected to a demodulation process, a decoding process, etc. in the radio communication unit 22, and outputs that information to the radio base station control station via the wired network. In addition, the base station controlling unit 23 has a function of controlling the radio communication unit 22 for controlling the time or the reference timing serving as the standard for starting the transmission of a radio signal from the radio communication unit 22.

The timing difference measuring unit 24 measures a difference between a reception timing and a transmission timing. The reception timing is timing at which the antenna 21 receives the reference signal 12 relating to inter-radio-base-station synchronization, the radio communication unit 22 performing a demodulation process, a decoding process, etc. on that received reference signal. The transmission timing is timing at which the associated radio base station transmits a radio signal. Specifically, the timing difference measuring unit 24 measures a timing difference between the reference timing of the first radio base station and the reference timing of the second radio base station adjacent to the first radio base station, using the reference signal 12 received from the second radio base station for synchronization of a reference timing, the reference timing being timing serving as a standard for starting transmission of a radio signal between radio base stations.

On the basis of the reference timing difference between radio base stations measured by the timing difference measuring unit 24, the timing correction controlling unit 25 determines a reference timing as a standard for inter-radio-base-station synchronization and calculates a first timing correction amount for the first radio base station and a second timing correction amount for the second radio base station. The first timing correction amount for the first radio base station is a timing correction amount by which to correct the reference timing of the first radio base station in order to synchronize the reference timing of the first radio base station and the reference timing of the second radio base station with each other. The second timing correction amount for the second radio base station is a timing correction amount by which to correct the reference timing of the second radio base station in order to synchronize the reference timing of the first radio base station and the reference timing of the second radio base station with each other.

The base station controlling unit 23 performs control to notify the second radio base station of the second timing correction amount for the second radio base station calculated by the timing correction controlling unit 25.

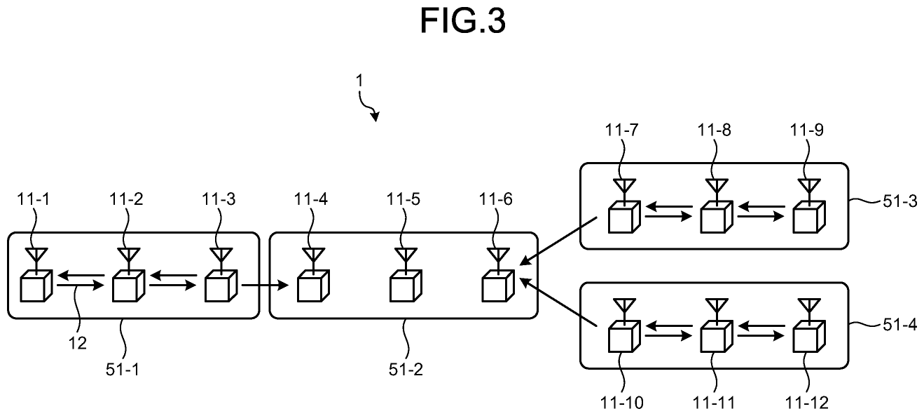

Next, the operation of a radio base station 11 will be explained. FIG. 3 is a diagram illustrating an example for explaining the operation of the radio base stations 11 in the radio communication system 1 according to the present embodiment. As illustrated in FIG. 3, radio base stations 11-1 to 11-3 are installed in an area 51-1, radio base stations 11-4 to 11-6 are installed in an area 51-2, radio base stations 11-7 to 11-9 are installed in an area 51-3, and radio base stations 11-10 to 11-12 are installed in an area 51-4. The areas 51-1 to 51-4 may be predetermined at installation. The number of radio base stations 11 installed in each of the areas 51-1 to 51-4 may be one or more and is not particularly limited. In the description below, the areas 51-1 to 51-4 may be referred to as areas 51 when the areas 51-1 to 51-4 are not distinguished from each other.

FIG. 3 illustrates the example in which the radio base stations 11-4 to 11-6 installed in the area 51-2 stop their operations due to maintenance, failure, etc. Under the situation illustrated in FIG. 3, the radio base stations 11 installed in the areas 51-1, 51-3, and 51-4 operate in inter-radio-base-station synchronization with neighboring radio base stations 11. Specifically, the radio base stations 11 do not necessarily establish inter-radio-base-station synchronization between the areas 51. Instead, each of the radio base stations 11 determines the timing for starting transmission of a radio signal, using its own reference timing in the associated area 51. The areas 51-1, 51-3, and 51-4 are at a certain distance or farther from each other. Although the radio base stations 11 installed in the individual areas 51 in the radio communication system 1 perform radio communication using their own reference timings, therefore, no interference occurs and no handover due to movement of radio terminals is performed.

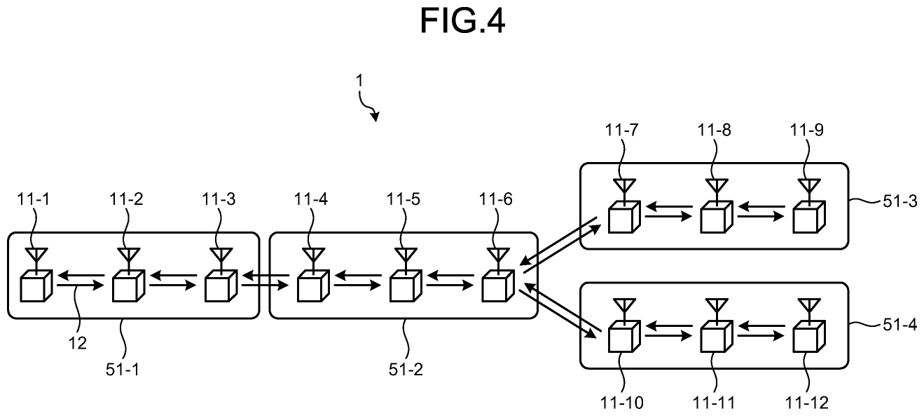

FIG. 4 is a diagram illustrating a situation under which the radio base stations 11-4 to 11-6 installed in the area 51-2 have resumed operation after the situation illustrated in FIG. 3 in the radio communication system 1 according to the present embodiment. After resuming operation, the radio base stations 11-4 to 11-6 each receive the reference signals 12 from the adjacent radio base stations 11, generate a reference timing of the associated radio base station, and start transmission and reception of the reference signals 12. As illustrated in FIG. 4, the radio base stations 11 installed in the area 51-2 are adjacent to the radio base stations 11 installed in the areas 51-1, 51-3, and 51-4. The areas 51-1, 51-3, and 51-4 can include a mixture of the radio base stations 11 that operate at their own reference timings based on the reference signals 12 in their areas 51.

When there is no timing difference in the reference signals 12, that is, no timing difference in the reference timings between the radio base stations 11 installed in the area 51-2 and the radio base stations 11 installed in the areas 51-1, 51-3, and 51-4, all the radio base stations 11 can be synchronized with each other. As described above, however, the radio base stations 11 installed in the areas 51-1, 51-3, and 51-4 transmit radio signals at their own reference timings independent of one another. Thus, the radio base stations 11-4, 11-5, and 11-6 installed in the area 51-2 may transmit radio signals at reference timings different from each other.

At which of the reference timings of the radio base stations 11 installed in the areas 51-1, 51-3, and 51-4 the radio base stations 11-4, 11-5, and 11-6 should start transmission of radio signals depends on the earliest received reference signal 12 among the reference signals received by the radio base stations 11-4, 11-5, and 11-6 after the radio base stations 11-4, 11-5, and 11-6 start operations. The present embodiment is based on the assumption, by way of example, that, among the radio base stations 11-4 to 11-6 installed in the area 51-2, the radio base station 11-4 was the earliest to receive a reference signal 12 transmitted by the radio base station 11-3 in the area 51-1. In addition, assume that the radio base stations 11-5 and 11-6 received the reference signal 12 transmitted from the radio base station 11-4 earlier than the reference signals 12 transmitted from the radio base stations 11-7 and 11-10. In FIG. 4, as a result, the radio base stations 11-1 to 11-6 transmit radio signals, using the same reference timing. Under such a situation, the radio base station 11-6 receives the reference signals 12 having different reference timings from the radio base stations 11-7 and 11-10, and recognizes that radio base stations 11 having different reference timings are present in the radio communication system 1.

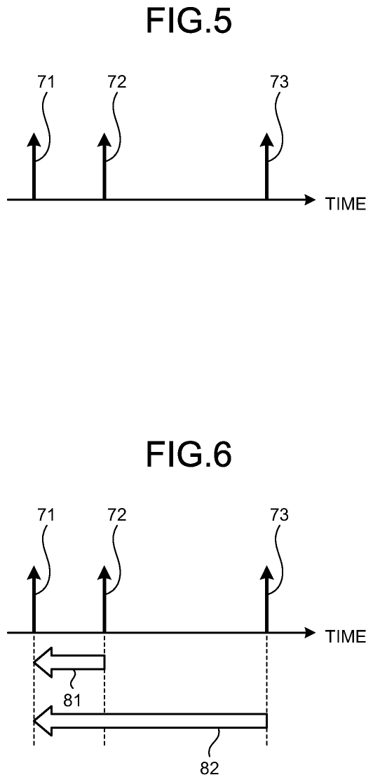

FIG. 5 is a diagram illustrating an example of relation of reference timings of radio base stations 11 in different areas 51 in the radio communication system 1 according to the present embodiment. Reference timings 71, 72, and 73 indicated by arrows in FIG. 5, which represent the reference timings of individual radio base stations 11, have temporal differences, i.e., timing differences therebetween. In the example of FIG. 5, assume that the reference timing of the radio base station 11-6 is the reference timing 71, the reference timing of the radio base station 11-7 is the reference timing 72, and the reference timing of the radio base station 11-10 is the reference timing 73. Under such a situation as illustrated in FIG. 5, the radio base stations 11 need to perform timing correction on the reference timings so that the timing differences between the reference timings 71 to 73 of the radio base stations 11 become smaller.

FIG. 6 is a first diagram illustrating an example of timing correction of reference timings performed by radio base stations 11 in the radio communication system 1 according to the present embodiment. FIG. 6 illustrates an example in which the radio base station 11-6 notifies the radio base stations 11-7 and 11-10 of the timing correction amounts so that the reference timings thereof become closer to the reference timing of the present radio base station 11-6. Specifically, the radio base station 11-6 notifies the radio base station 11-7 of a timing correction amount 81, and notifies the radio base station 11-10 of a timing correction amount 82. The radio base station 11-6 may perform notification of the timing correction amounts through wireless communication, using radio signals or through wire communication via the wired network with which the radio base stations 11 are connected. Specifically, in the radio base station 11-6, the base station controlling unit 23 performs control to notify the second radio base station of the second timing correction amount, using wireless communication or wire communication.

As illustrated in FIG. 6, the timing correction amounts 81 and 82 of the radio base stations 11-7 and 11-10 are very large. In the presence of wireless terminals in communication with the radio base stations 11-7 and 11-10, the radio base stations 11-7 and 11-10 carry out timing correction in small amounts to such an extent as not to affect the communication with the wireless terminals. In this case, it takes a significantly large time for the radio base stations 11-7 and 11-10 of the radio communication system 1 to complete the timing correction. This results in an extension of the time taken to complete inter-radio-base-station synchronization. Such a phenomenon occurs, for example, in a case where a radio base station 11 having the reference timing serving as a standard for inter-radio-base-station synchronization was set in advance.

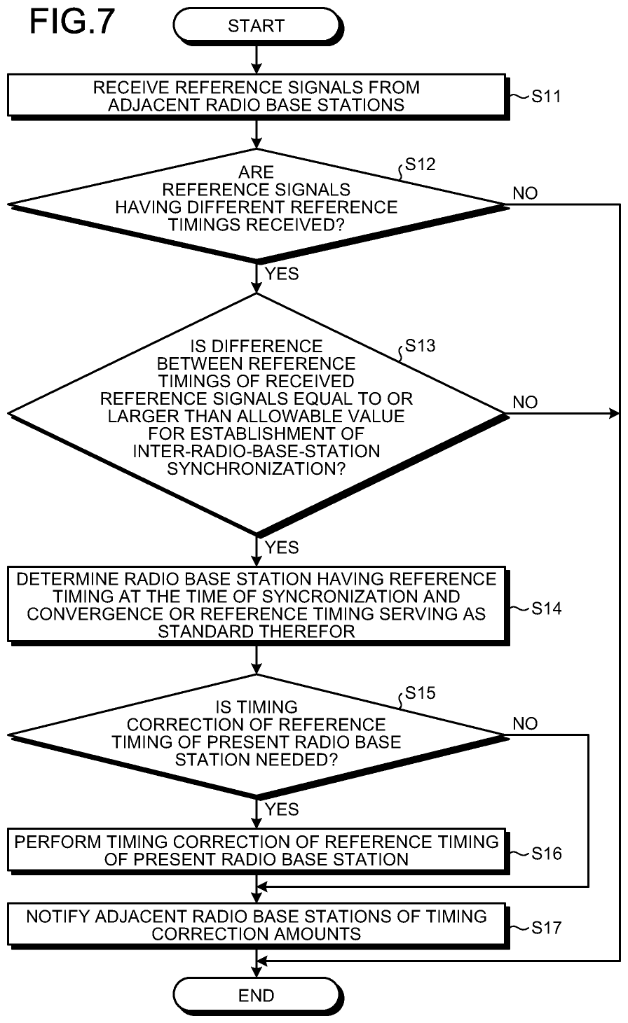

In view of this, in the present embodiment, the radio base station 11-6 that has received a plurality of reference signals 12 having different reference timings determines a reference timing to which the reference timings converge to shorten the time taken to establish the inter-radio-base-station synchronization. FIG. 7 is a flowchart illustrating the operation for establishing inter-radio-base-station synchronization when a radio base station 11 according to the present embodiment has received reference signals 12 having different reference timings from a plurality of radio base stations 11. Upon receiving reference signals 12 from the adjacent radio base stations 11-7 and 11-10 (step S11), the radio base station 11-6 determines whether or not reference signals 12 having different reference timings are received (step S12). If the reference signals 12 having different reference timings are not received (step S12: No), the radio base station 11-6 terminates the operation for establishing inter-radio-base-station synchronization.

If the reference signals 12 having different reference timings are received (step S12: Yes), the radio base station 11-6 compares the reference timings of the received reference signals 12 with each other, and determines whether or not the difference between the reference timings of the reference signals 12 is equal to or larger than an allowable value for establishment of inter-radio-base-station synchronization (step S13). The allowable value is a value determined during design of the radio communication system 1 on the basis of the performance of a physical layer of radio communication, a guard time set to prevent interference between radio signals in radio communication, or the like. The radio base station 11-6 holds information on the allowable value in advance. If the difference between the reference timings of the reference signals 12 is smaller than the allowable value for establishment of inter-radio-base-station synchronization (step S13: No), the radio base station 11-6 determine that inter-radio-base-station synchronization is established and terminates the operation for establishing inter-radio-base-station synchronization.

If the difference between the reference timings of the reference signals 12 is equal to or larger than the allowable value for establishment of inter-radio-base-station synchronization (step S13: Yes), the radio base station 11-6 determines that inter-radio-base-station synchronization is not established, and determines a radio base station 11 having a reference timing to which the reference timings converge as a result of timing correction, i.e., a reference timing at the time of the synchronization and convergence or a reference timing serving as a standard therefor (step S14).

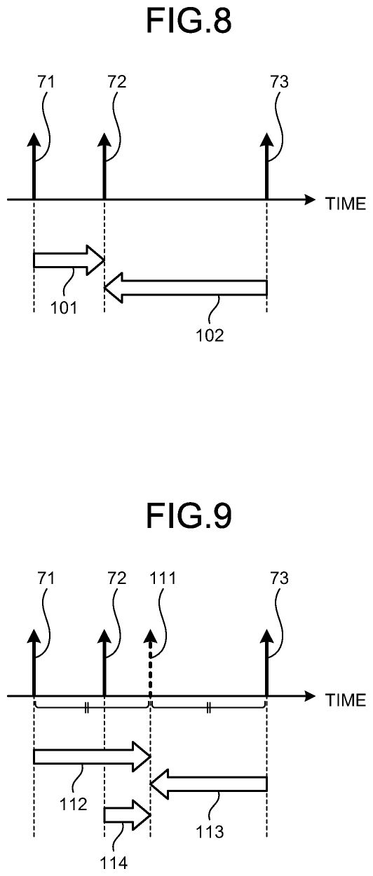

FIG. 8 is a second diagram illustrating an example of timing correction of reference timings performed by radio base stations 11 in the radio communication system 1 according to the present embodiment. FIG. 8 illustrates an example in which the reference timings converge to the reference timing of any of the radio base stations 11 having different reference timings. Specifically, FIG. 8 illustrates an example in which reference timings are corrected so that the reference timings of all the radio base stations 11 become the reference timing 72 of the radio base station 11-7. Specifically, the timing correction controlling unit 25 of the radio base station 11-6 determines a reference timing such that a sum of the first timing correction amount and the second timing correction amounts is smallest, the reference timing serving as a standard at the time of synchronization and convergence. The timing correction controlling unit 25 selects one of the reference timing of the first radio base station or the reference timing of a second radio base station, as the reference timing serving as a standard at the time of synchronization and convergence. In this manner, the radio base station 11-6 can make the sum of timing correction amounts 101 and 102 illustrated in FIG. 8 smaller than the sum of the timing correction amounts 81 and 82 illustrated in FIG. 6. The radio base station 11-6 can therefore shorten the time until completion of timing correction of the reference timings of the radio base stations 11.

FIG. 9 is a third diagram illustrating an example of timing correction of reference timings performed by radio base stations 11 in the radio communication system 1 according to the present embodiment. FIG. 9 illustrates an example of a reference timing at the time of synchronization and convergence. FIG. 9 illustrates an example of setting a median value of the reference timings 71 to 73 as a reference timing 111 at the time of synchronization and convergence instead of selecting a radio base station 11 having the reference timing serving as a standard as illustrated in FIG. 8. In this case, the timing correction amounts for the radio base stations 11-6, 11-7, and 11-10 are timing correction amounts 112, 113, and 114, respectively. Specifically, the timing correction controlling unit 25 of the radio base station 11-6 determines a timing of a median value of the reference timings of two radio base station 11 having the largest timing difference, as a reference timing serving as a standard at the time of synchronization and convergence. In this manner, the radio base station 11-6 can make maximum timing correction amounts 112 and 113 illustrated in FIG. 9 smaller than the maximum timing correction amount 102 illustrated in FIG. 8 although the sum of timing correction amounts 112, 113, and 114 illustrated in FIG. 9 is larger than the sum of the timing correction amounts 101 and 102 illustrated in FIG. 8. In view of the radio base stations 11 concurrently performing timing correction, therefore, the radio base station 11-6 can further shorten the time until completion of timing correction of the reference timings of the radio base stations 11.

Note that, in the operation in step S14, the radio base station 11-6 determines a radio base station 11 having the reference timing at the time of synchronization and convergence or the reference timing serving as a reference therefor, and calculates the timing correction amounts for the radio base stations 11 including the radio base station 11-6.

If timing correction of the reference timing is needed in the radio base station 11-6 (step S15: Yes), the radio base station 11-6 performs timing correction of the reference timing of the radio base station 11-6 (step S16). If timing correction of the reference timing is not needed in the radio base station 11-6 (step S15: No) or after the operation of step S16, the radio base station 11-6 notifies each of the adjacent radio base stations 11 of a timing correction amount (step S17). Specifically, the radio base station 11-6 notifies the radio base stations 11-7 and 11-10 of the timing correction amounts. In addition, when the radio base station 11-6 has corrected the reference timing of the radio base station 11-6, the radio base station 11-6 also notifies the radio base station 11-5 of the timing correction amount. The radio base station 11-6 may perform notification of the timing correction amounts through wireless communication or through wire communication via the wired network interconnecting the radio base stations 11, as described above.

In notifying the adjacent radio base stations of the timing correction amounts, the radio base station 11-6 also notifies the adjacent radio base stations of the number of radio base stations 11 considered for determining the reference timing. The number of radio base stations 11 when the radio base station 11-6 notifies the radio base stations 11-7 and 11-10 of the timing correction amounts is three. Specifically, the timing correction controlling unit 25 of the radio base station 11-6 notifies the base station controlling unit 23 of the number of radio base stations considered in determining the first timing correction amount and the second timing correction amounts. The base station controlling unit 23 notifies the second radio base stations of the number of radio base stations together with the second timing correction amounts.

The radio base stations 11-5, 11-7, and 11-10 each correct the reference timing thereof on the basis of the timing correction amount of which each of the radio base stations 11-5, 11-7, and 11-10 is notified. Each of the radio base stations 11-5, 11-7, and 11-10 performs correction of the reference timing for a radio base station 11 that transmitted a radio signal at the same timing as that radio base station before the radio base station starts the correction. For example, the radio base station 11-7 performs correction of the reference timing for the radio base station 11-8. Alternatively, the radio base stations 11-5, 11-7, and 11-10 may each correct the frame timing thereof in steps of a small amount. When the reference signals 12 transmitted by the radio base stations 11-5, 11-7, and 11-10 are received by adjacent radio base stations 11 at shifted timings, the radio base stations 11-5, 11-7, and 11-10 can cause the reference timing of the associated adjacent radio base stations 11 to be autonomously corrected.

As illustrated in FIG. 3, the radio base stations 11-7 and 11-10 can receive the reference signals 12 from the radio base station 11-6, compare the received reference signals 12 with their own reference timings and notify the radio base station 11-6 of timing correction amounts in accordance with the flowchart illustrated in FIG. 7. As described above, in notifying the adjacent radio base stations, the individual radio base stations 11 also notify the adjacent radio base stations of the number of radio base stations 11 considered for determining the timing correction amounts. When each radio base station 11 is notified of a timing correction amount from an adjacent radio base station 11 after having transmitted the reference signal 12 to the adjacent radio base station 11, the radio base station 11 compares the number of radio base stations 11 of which the adjacent radio base station 11 notified that radio base station, with the number of radio base stations 11 which that radio base station considered in determining the timing correction amounts. When a result of comparison of the numbers of radio base stations 11 shows that the number of radio base stations 11 included in the timing correction amount of which the radio base station is notified is larger, the radio base station 11 performs timing correction in accordance with the timing correction amount of which the radio base station 11 is notified.

In the present embodiment, the radio base stations 11-7 and 11-10 are notified of three as the number of radio base stations 11 by the radio base station 11-6. Because the timing correction amount of which each of the radio base stations 11-7 and 11-10 notified the radio base station 11-6 takes into consideration only the radio base station itself and the radio base station 11-6, the number of radio base stations 11 considered is two. The number of radio base stations 11 of which the radio base station 11-6 notified each of the radio base stations 11-7 and 11-10 is larger than that considered by the radio base stations 11-7 and 11-10. Thus, the radio base stations 11-7 and 11-10 perform timing correction of the reference timing in accordance with the timing correction amounts of which the radio base station 11-6 notified the radio base stations 11-7 and 11-10.

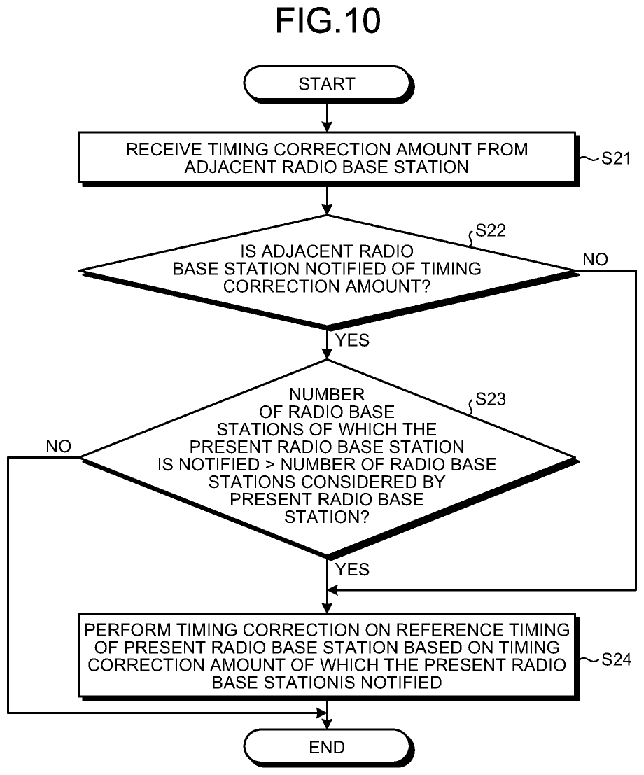

FIG. 10 is a flowchart illustrating the operations of the radio base stations 11-7, 11-10 in receipt of timing correction amounts according to the present embodiment. The radio base stations 11-7, 11-10 receive timing correction amounts from the adjacent radio base station 11-6 (step S21). The radio base station 11-7, 11-10 determine whether or not these radio base stations have notified the adjacent radio base station 11-6 of timing correction amounts (step S22). If the radio base station 11-7, 11-10 have notified the adjacent radio base station 11-6 of the timing correction amounts (step S22: Yes), the radio base station 11-7, 11-10 compare information on the number of radio base stations 11 of which the radio base station 11-7, 11-10 are notified together with the timing correction amounts, with the number of radio base stations 11 considered by the present radio base stations 11, i.e., 11-7, 11-10 (step S23). If the number of radio base stations 11 of which the radio base station 11-7, 11-10 are notified together with the timing correction amounts is larger (step S23: Yes) or if the radio base station 11-7, 11-10 have not notified the adjacent radio base station 11-6 of timing correction amounts (step S22: No), the radio base station 11-7, 11-10 perform timing correction of their reference timings on the basis of the timing correction amounts of which the radio base station 11-7, 11-10 are notified (step S24). If the number of radio base stations 11 of which the radio base station 11-7 or 11-10 is notified together with the timing correction amount is smaller (step S23: No), the radio base station 11-7 or 11-10 terminates the operation without correcting their reference timings.

The same is applicable to the radio base station 11-6. Specifically, the base station controlling unit 23 of the radio base station 11-6 notifies a second radio base station of a second timing correction amount, and when the radio base station 11-6 is notified of a first timing correction value determined by the second radio base station by the second radio base station, the base station controlling unit 23 employs the timing correction amount for which the number of radio base stations 11 considered is larger, on the basis of the numbers of radio base stations 11.

Although the present embodiment has been described giving an example in which the radio base station 11-6 receives reference signals 12 having different reference timings from two adjacent radio base stations 11, specifically, the radio base stations 11-7 and 11-10, the embodiment is not limited thereto. The present embodiment is also applicable to cases where a radio base station 11 receives reference signals 12 having different reference timings from three or more adjacent radio base stations 11.

Next, a hardware configuration of a radio base station 11 will be described. In the radio base station 11, the antenna 21 is an antenna element. The radio communication unit 22 is a radio communication module including a radio frequency circuit for radio communication, a modulation/demodulation circuit, and the like. The base station controlling unit 23, the timing difference measuring unit 24, and the timing correction controlling unit 25 are implemented by processing circuitry. The processing circuitry may be constituted by a processor that executes programs stored in a memory and the memory, or may be dedicated hardware. The processing circuitry is also called a control circuit.

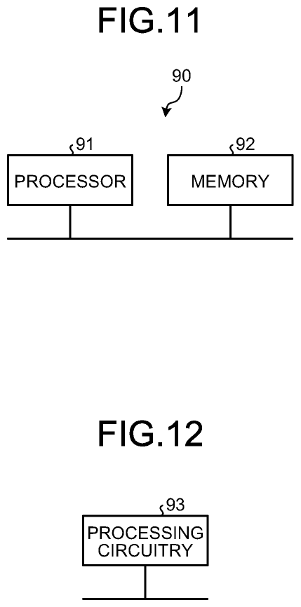

FIG. 11 is a diagram illustrating an example of a configuration of processing circuitry 90 in a case where the processing circuitry included in a radio base station 11 according to the present embodiment is implemented by a processor and a memory. The processing circuitry 90 illustrated in FIG. 11 is a control circuit including a processor 91 and a memory 92. In the case where the processing circuitry 90 is constituted by the processor 91 and the memory 92, the functions of the processing circuitry 90 are implemented by software, firmware, or a combination of software and firmware. The software or firmware is described in the form of programs and stored in the memory 92. The processing circuitry 90 implements the functions by reading and executing the programs stored in the memory 92 by the processor 91. Specifically, the processing circuitry 90 includes the memory 92 for storing programs that results in execution of processes of the radio base station 11. The programs are, in other words, programs for causing the radio base station 11 to perform the functions implemented by the processing circuitry 90. The programs may be provided by a storage medium storing the programs, or may be provided by other means such as a communication medium.

The programs are, in other words, programs for causing a radio base station 11 to perform a first step in which the timing difference measuring unit 24 measures a timing difference between a reference timing of a first radio base station and a reference timing of a second radio base station adjacent to the first radio base station, using a reference signal 12 received from the second radio base station for synchronization of the reference timing that is timing serving as a standard for starting transmission of a radio signal between radio base stations, a second step in which the timing correction controlling unit 25 calculates a first timing correction amount, which is a timing correction amount by which to correct the reference timing of the first radio base station, and a second timing correction amount, which is a timing correction amount by which to correct the reference timing of the second radio base station, for synchronization of the reference timing of the first radio base station with the reference timing of the second radio base station, on the basis of the timing difference, and a third step in which the base station controlling unit 23 performs control to notify the second radio base station of the second timing correction amount.

Note that the processor 91 is a central processing unit (CPU), a processing device, a computing device, a microprocessor, a microcomputer, a digital signal processor (DSP), or the like, for example. In addition, the memory 92 is a nonvolatile or volatile semiconductor memory such as a random access memory (RAM), a read only memory (ROM), a flash memory, an erasable programmable ROM (EPROM), or an electrically EPROM (EEPROM: registered trademark), a magnetic disk, a flexible disk, an optical disk, a compact disc, a mini disc, a digital versatile disc (DVD) or the like, for example.

FIG. 12 is a diagram illustrating an example of processing circuitry 93 in a case where the processing circuitry included in a radio base station 11 according to the present embodiment is constituted by dedicated hardware. The processing circuitry 93 illustrated in FIG. 12 is a single circuit, a composite circuit, a programmed processor, a parallel-programmed processor, an application specific integrated circuit (ASIC), a field programmable gate array (FPGA), or a combination thereof, for example. Part of the processing circuitry may be implemented by dedicated hardware, and part thereof may be implemented by software or firmware. As described above, the processing circuitry is capable of implementing the above-described functions by dedicated hardware, software, firmware, or a combination thereof.

As described above, according to the present embodiment, a radio base station 11 receives a reference signal 12 from an adjacent radio base station 11, and when the difference between the reference timings is equal to or larger than the allowable value, determines a reference timing so that the sum of the timing correction amounts for the radio base stations 11 including that radio base station is smallest. In this manner, the radio communication system 1 can quickly establish temporal synchronization between radio base stations 11 installed in the radio communication system 1. The radio communication system 1 can shorten the time to establishment of synchronization between the radio base stations 11.

Note that, as also described in the Background section, the radio base stations 11 can also synchronize the points of time managed by the respective radio base stations 11, as synchronization of reference timings.

The configurations presented in the embodiment above are examples, and can be combined with other known technologies or with each other, or can be partly omitted or modified without departing from the gist.

### REFERENCE SIGNS LIST

1 radio communication system; 11, 11-1 to 11-12 radio base station; 12 reference signal; 21 antenna; 22 radio communication unit; 23 base station controlling unit; 24 timing difference measuring unit; 25 timing correction controlling unit; 51-1 to 51-4 area.

1. A radio base station being a first radio base station among a plurality of radio base stations of a radio communication system, the radio base station comprising:
timing difference measuring circuitry to measure a timing difference between a reference timing of the first radio base station and a reference timing of a second radio base station adjacent to the first radio base station, using a reference signal received from the second radio base station for synchronization of a reference timing that is timing serving as a standard for starting transmission of a radio signal between radio base stations;
timing correction controlling circuitry to calculate a first timing correction amount and a second timing correction amount for synchronization of the reference timing of the first radio base station with the reference timing of the second radio base station, on the basis of the timing difference, the first timing correction amount being a timing correction amount by which to correct the reference timing of the first radio base station, the second timing correction amount being a timing correction amount by which to correct the reference timing of the second radio base station; and
base station controlling circuitry to perform control to notify, from the first radio base station, the second radio base station of the second timing correction amount.

2. The radio base station according to claim 1, wherein
the timing correction controlling circuitry determines a reference timing such that a sum of the first timing correction amount and the second timing correction amount is smallest, the reference timing serving as a standard at a time of synchronization and convergence.

3. The radio base station according to claim 2, wherein
the timing correction controlling circuitry selects one of the reference timing of the first radio base station and the reference timing of the second radio base station, as the reference timing providing the smallest sum.

4. The radio base station according to claim 1, wherein the timing correction controlling circuitry determines a timing of a median value of reference timings of two radio base stations having a largest timing difference, as the reference timing serving as a standard at a time of synchronization and convergence.

5. The radio base station according to claim 1, wherein
the base station controlling circuitry performs control to notify the second radio base station of the second timing correction amount, using wireless communication or wire communication.

6. The radio base station according to claim 1, wherein
the timing correction controlling circuitry notifies the base station controlling circuitry of the number of radio base stations considered in determining the first timing correction amount and the second timing correction amount, and
the base station controlling circuitry notifies the second radio base station of the number of radio base stations together with the second timing correction amount.

7. The radio base station according to claim 6, wherein
the base station controlling circuitry notifies the second radio base station of the second timing correction amount, and when the radio base station is notified of a first timing correction value determined by the second radio base station by the second radio base station, the base station controlling circuitry employs a timing correction amount for which the number of radio base stations is larger, on the basis of the numbers of radio base stations.

8. The radio base station according to claim 1, wherein
points of times managed by individual radio base stations are synchronized with one another as synchronization of the reference timings.

9. A radio communication system comprising a plurality of radio base stations each being the radio base station according to claim 1.

10. A control circuit for controlling a radio base station being a first radio base station among a plurality of radio base stations of a radio communication system, the control circuit causing the radio base station to:
measure a timing difference between a reference timing of the first radio base station and a reference timing of a second radio base station adjacent to the first radio base station, using a reference signal received from the second radio base station for synchronization of a reference timing that is timing serving as a standard for starting transmission of a radio signal between radio base stations;
calculate a first timing correction amount and a second timing correction amount for synchronization of the reference timing of the first radio base station with the reference timing of the second radio base station, on the basis of the timing difference, the first timing correction amount being a timing correction amount by which to correct the reference timing of the first radio base station, the second timing correction amount being a timing correction amount by which to correct the reference timing of the second radio base station; and
perform control to notify, from the first radio base station, the second radio base station of the second timing correction amount.

11. A non-transitory storage medium storing a program for controlling a radio base station being a first radio base station among a plurality of radio base stations of a radio communication system, the program causing the radio base station to:
measure a timing difference between a reference timing of the first radio base station and a reference timing of a second radio base station adjacent to the first radio base station, using a reference signal received from the second radio base station for synchronization of a reference timing that is timing serving as a standard for starting transmission of a radio signal between radio base stations;
calculate a first timing correction amount and a second timing correction amount for synchronization of the reference timing of the first radio base station with the reference timing of the second radio base station, on the basis of the timing difference, the first timing correction amount being a timing correction amount by which to correct the reference timing of the first radio base station, the second timing correction amount being a timing correction amount by which to correct the reference timing of the second radio base station; and
perform control to notify, from the first radio base station, the second radio base station of the second timing correction amount.

12. A radio communication method for a radio base station being a first radio base station among a plurality of radio base stations of a radio communication system, the radio communication method comprising:
measuring a timing difference between a reference timing of the first radio base station and a reference timing of a second radio base station adjacent to the first radio base station, using a reference signal received from the second radio base station for synchronization of a reference timing that is timing serving as a standard for starting transmission of a radio signal between radio base stations;
calculating a first timing correction amount and a second timing correction amount for synchronization of the reference timing of the first radio base station with the reference timing of the second radio base station, on the basis of the timing difference, the first timing correction amount being a timing correction amount by which to correct the reference timing of the first radio base station, the second timing correction amount being a timing correction amount by which to correct the reference timing of the second radio base station; and
performing control to notify, from the first radio base station, the second radio base station of the second timing correction amount.
